(19) United States
(12) Patent Application Publication
(10) Pub. No.: US 2005/0102144 A1
(43) Pub. Date: May 12, 2005

(54) Speech synthesis

(76) Inventor: Ezra J. Rapoport, New York, NY (US)

Correspondence Address: FISH & RICHARDSON PC, 225 FRANKLIN ST, BOSTON, MA, 02110, US

(21) Appl. No.: 10/704,326

(22) Filed: Nov. 6, 2003

(51) Int. Cl. G10L 13/00

(52) U.S. Cl. 704/269

(57) ABSTRACT

A method for speech synthesis includes combining principal components corresponding to a phoneme with a set of coefficients to produce a signal representing a synthesized expression of the phoneme. The method may also include applying the synthesized expression to a transducer to generate synthesized speech. The method may include generating the phoneme from text.

### BACKGROUND

This invention relates to speech synthesis.

Speech synthesis involves generation of simulated human speech. Typically, computers are used to generate the simulated human speech from text input. For instance, a machine has text in a book inputted via some mechanism, such as scanning the text and applying optical character recognition to produce a text file that is sent to a speech synthesizer to produce corresponding synthesized speech signals that are sent to a speaker to provide an audible output from the machine.

### SUMMARY

Quasi-periodic waveforms can be found in many areas of the natural sciences. Quasi-periodic waveforms are observed in data ranging from heartbeats to population statistics, and from nerve impulses to weather patterns. The “patterns” in the data are relatively easy to recognize. For example, nearly everyone recognizes the signature waveform of a series of heartbeats. However, programming computers to recognize these quasi-periodic patterns is difficult because the data are not patterns in the strictest sense because each quasi-periodic data pattern recurs in a slightly different form with each iteration. The slight pattern variation from one period to the next is characteristic of “imperfect” natural systems. It is, for example, what makes human speech sound distinctly human. The inability of computers to efficiently recognize quasi-periodicity is a significant impediment to the analysis and storage of data from natural systems. Many standard methods require such data to be stored verbatim, which requires large amounts of storage space.

In one aspect the invention is a method for speech synthesis. The method includes combining principal components corresponding to a phoneme with a set of coefficients to produce a signal representing a synthesized expression of the phoneme.

In another aspect, the invention is an article that includes a machine-readable medium that stores executable instructions for speech synthesis. The instructions cause a machine to combine principal components corresponding to a phoneme with a set of coefficients to produce a signal representing a synthesized expression of the phoneme.

In a further aspect, the invention is an apparatus that includes a memory that stores executable instructions for speech synthesis. The apparatus also includes a processor that executes the instructions to combine principal components corresponding to a phoneme with a set of coefficients to produce a signal representing a synthesized expression of the phoneme.

By using a principal component analysis approach for providing speech synthesis, less speech pattern data is required to be stored resulting in less storage space. Also, using less speech pattern data to combine principal components with the coefficients, reduces the processing time that is required to produce synthesized speech.

### DESCRIPTION OF THE DRAWINGS

FIG. 1 is a block diagram of a speech synthesis system.

FIG. 2 is a flowchart of a process for speech synthesis.

FIG. 3 is a flowchart of a process to determine a pitch period.

FIG. 4 is an input waveform showing the relationship between vector length, buffer length and pitch periods.

FIG. 5 is an amplitude versus time plot of a sampled waveform of a pitch period.

FIGS. 6A-6C are plots representing a relationship between data and principal components.

FIG. 7 is a flowchart of a process to determine principal components and coefficients.

FIG. 8 is a plot of an eigenspectrum for a phoneme.

FIG. 9 is a block diagram of a computer system on which the process of FIG. 2 may be implemented.

### DESCRIPTION

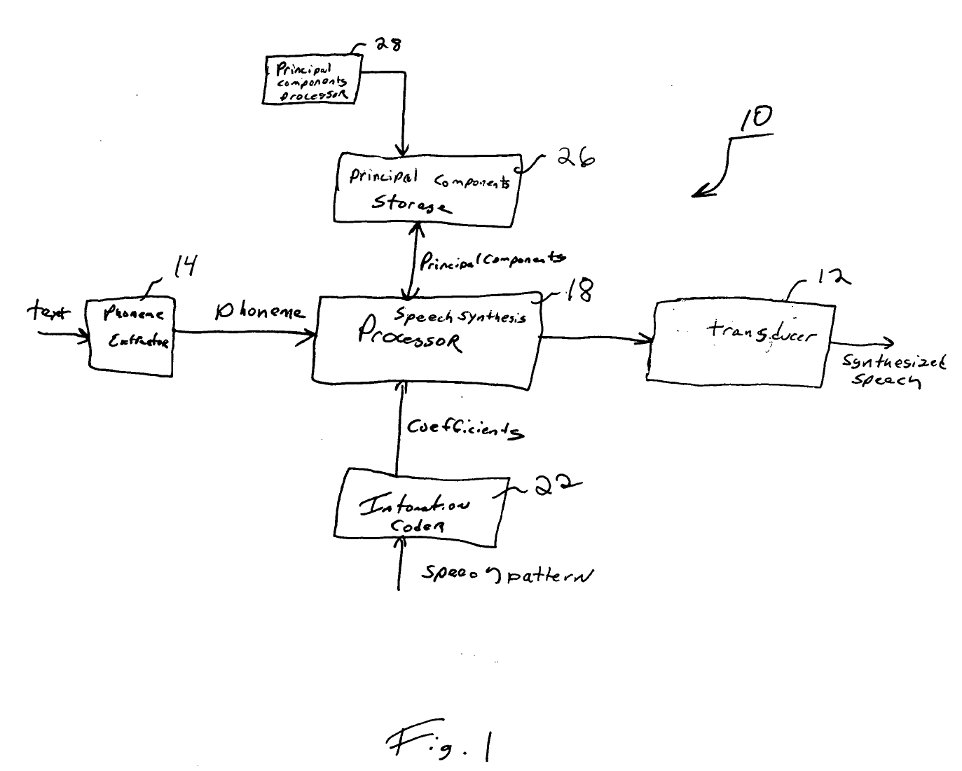

Referring to FIG. 1, a speech synthesizer 10 includes a transducer 12, phoneme extractor 14, a speech synthesizer processor 18, an intonation coder 22, a principal component storage 26, and a principal components processor 28. Principal component analysis (PCA) is a linear algebraic transform. PCA is used to determine the most efficient orthogonal basis for a given set of data. When determining the most efficient axes, or principal components of a set of data using PCA, a strength (i.e., an importance value called herein as a coefficient) is assigned to each principal component of the data set. In this disclosure, coefficients that include intonation in a person's speech are combined with previously saved principal components that correspond to an input text or phoneme to produce synthesized speech.

A phoneme extractor 14 receives a text message and converts the text into phonemes. An intonation coder 26 generates coefficients that correspond a person's intonations. The intonations of the speaker's speech pattern are, for example, intonations such as a deep voice or a soft pitch. These intonations can be selected by the user. Processor 18 receives phonemes and extracts principal components from a principal component storage 26 that correspond to the phonemes. Processor 18 combines the principal components and the coefficients and send the resultant combination to transducer 12 to produce synthesized speech.

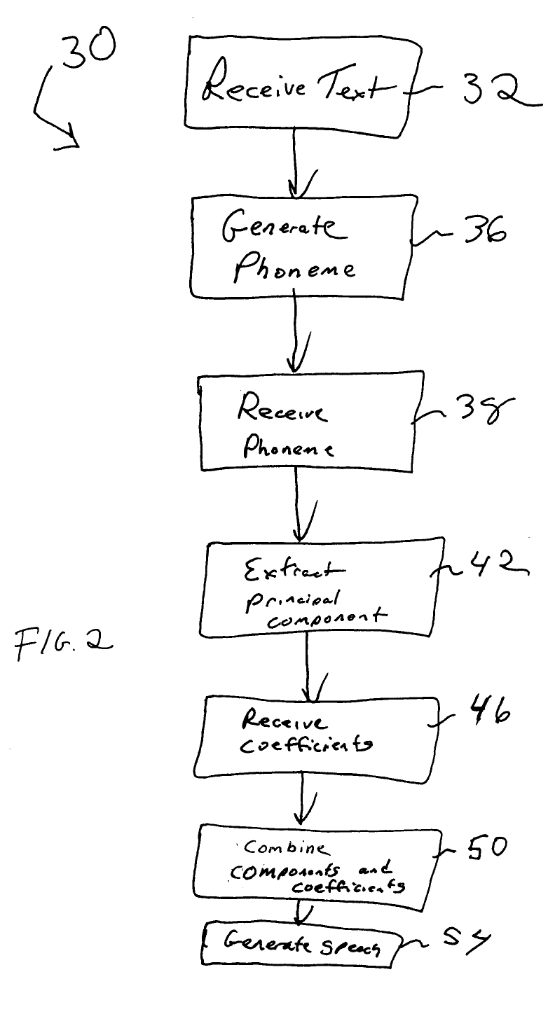

Referring to FIG. 2, an exemplary process 30 for producing synthesized speech is shown. Process 30 receives (32) text. For example, an optical scanner (not shown) scans a page of text or image and using optical character recognition (OCR) techniques produces a text file output. Process 30 generates (36) phonemes that correspond to the text file output. That is, text from the text file is fed to phoneme extractor 14 to convert the text into phonemes. Process 30 receives (38) the phonemes and uses the extracted phonemes as an index or address into the principal component storage 26 to extract (42) those principal components from principal component storage 26 that correspond to the phonemes. Process 30 receives (46) coefficients. For example, the coefficients are derived from a person's speech pattern. For example, a person speaks into intonation coder 22 and the coefficients are derived from the speech. Intonation coder 22 modifies the coefficients to correspond with different voice intonations. Process 30 combines (50) the coefficients with the principal components and generates (54) the combination as synthesized speech, as further described below.

The speech construction process synthesizes a waveform by sequentially constructing each pitch period (described below), scaling the principal components by the coefficients for a given period, and summing the scaled components. As each pitch period is constructed, the pitch period is concatenated to the prior pitch period to construct the waveform.

In operation, a person's principal components encompassing a typical vocabulary are stored in principal component storage 26 (the actual determining of principal components is described below). For example, suppose the principal components, from a mother, have been previously stored in principal component storage 26 and speech synthesizer 10 is embodied in a text reader for a blind child. Speech synthesizer 10 would read words from a book and convert them into synthesized speech that replicates a mother's voice. In a further example, intonation coder 22 may be set to a soft tone. Thus, a blind child is able to hear a story from a soft voice replicating the mother's voice prior to bedtime.

As described above, principal component storage 26 includes principal components. For example, a person inputs the vocabulary desired to be used by speech synthesizer 10 by reading the vocabulary into a principal components processor 28 (through a second transducer (not shown)) that extracts the principal components from the words spoken and stores them in principal component storage 26 for retrieval using process 30. The entire waveform of each word is not saved, but just the principal components thus saving storage space.

One exemplary process, used by principal components processor 28 for determining principal components for storage in principal component storage 26, determines the pitch periods (pitch-tracking process 62) and the principal components are determined based on the pitch periods (principal components process 64).

A. Pitch Tracking

In order to analyze the changes that occur from one pitch period to the next, a waveform is divided into its pitch periods using pitch-tracking process 62.

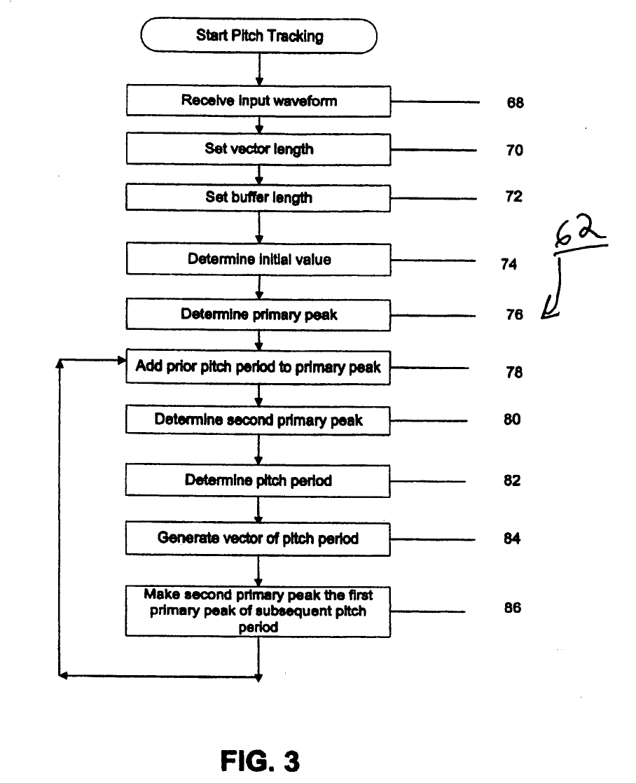

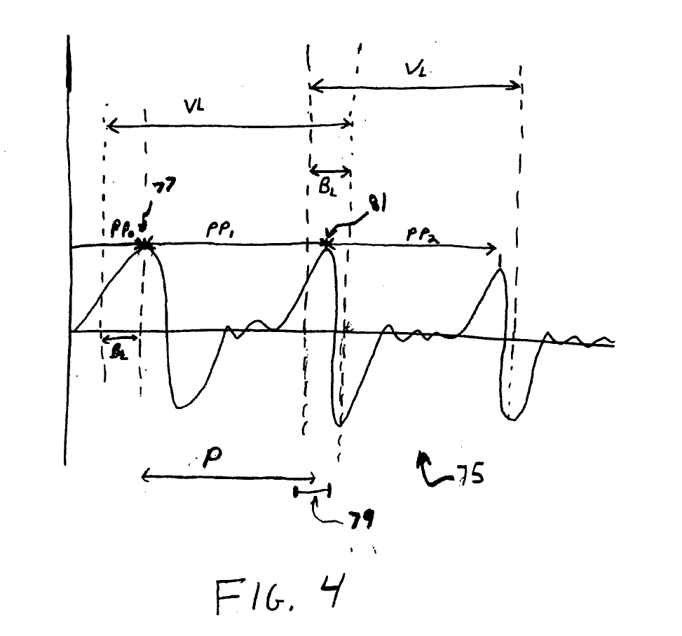

Referring to FIGS. 3 and 4, pitch-tracking process 62 receives (68) an input waveform 75 to determine the pitch periods. Even though the waveforms of human speech are quasi-periodic, human speech still has a pattern that repeats for the duration of the input waveform 75. However, each iteration of the pattern, or “pitch period” (e.g., PP₁) varies slightly from its adjacent pitch periods, e.g., PP₀ and PP₂. Thus, the waveforms of the pitch periods are similar, but not identical, thus making the time duration for each pitch period unique.

Since the pitch periods in a waveform vary in time duration, the number of sampling points in each pitch period generally differs and thus the number of dimensions required for each vectorized pitch period also differs. To adjust for this inconsistency, pitch-tracking process 62 designates (70) a standard vector (time) length, V_{L}. After pitch-tracking process 62 is executing, the pitch tracking process chooses a vector length to be the average pitch period length plus a constant, for example, 40 sampling points. This allows for an average buffer of 20 sampling points on either side of a vector. The result is that all vectors are of a uniform length and can be considered members of the same vector space. Thus, vectors are returned where each vector has the same length and each vector includes a pitch period.

Pitch tracking process 62 also designates (72) a buffer (time) length, B_{L}, which serves as an offset and allows the vectors of those pitch periods that are shorter than the vector length to run over and include sampling points from the next pitch period. As a result, each vector returned has a buffer region of extra information at the end. This larger sample window allows for more accurate principal component calculations, but also requires a greater bandwidth for transmission. In the interest of maximum bandwidth reduction, the buffer length may be kept to between 10 and 20 sampling points (vector elements) beyond the length of the longest pitch period in the waveform.

At 8 kHz, a vector length that includes 120 sample points and an offset that includes 20 sampling units can provide optimum results.

Pitch tracking process 62 relies on the knowledge of the prior period duration, and need not determine the duration of the first period in a sample directly. Therefore, pitch-tracking process 62 determines (74) an initial period length value by finding a “real cepstrum” of the first few pitch periods of the speech signal to determine the frequency of the signal. A “cepstrum” is an anagram of the word “spectrum” and is a mathematical function that is the inverse Fourier transform of the logarithm of the power spectrum of a signal. The cepstrum method is a standard method for estimating the fundamental frequency (and therefore period length) of a signal with fluctuating pitch.

A pitch period can begin at any point along a waveform, provided it ends at a corresponding point. Pitch tracking process 62 considers the starting point of each pitch period to be the primary peak or highest peak of the pitch period.

Pitch tracking process 62 determines (76) the first primary peak 77. Pitch tracking process 62 determines a single peak by taking the input waveform, sampling the input waveform, taking the slope between each sample point and taking the point sampling point closest to zero. Pitch tracking process 62 searches several peaks and takes the peak with the largest magnitude as the primary peak 77. Pitch tracking process 62 adds (78) the prior pitch period to the primary peak. Pitch tracking process 62 determines (80) a second primary peak 81 locating a maximum peak from a series of peaks 79 centered a time period, P, (equal to the prior pitch period, PP₀) from the first primary peak 77. The peak whose time duration from the primary peak 77 is closest to the time duration of the prior pitch period PP₀ is determined to be the ending point of that period (PP₁) and the starting point of the next (PP₁). The second primary peak is determined by analyzing three peaks before or three peaks after the prior pitch period from the primary peak and designating the largest peak of those peaks as the second peak.

Process 60 vectorizes (84) the pitch period. Performing pitch tracking process 62 recursively, pitch tracking process 62 returns a set of vectors; each set corresponding to a vectorized pitch period of the waveform. A pitch period is vectorized by sampling the waveform over that period, and assigning the ith sample value to the ith coordinate of a vector in Euclidean n-dimensional space, denoted by [symbol] ⁿ, where the index i runs from 1 to n, the number of samples per period. Each of these vectors is considered a point in the space [symbol] ⁿ.

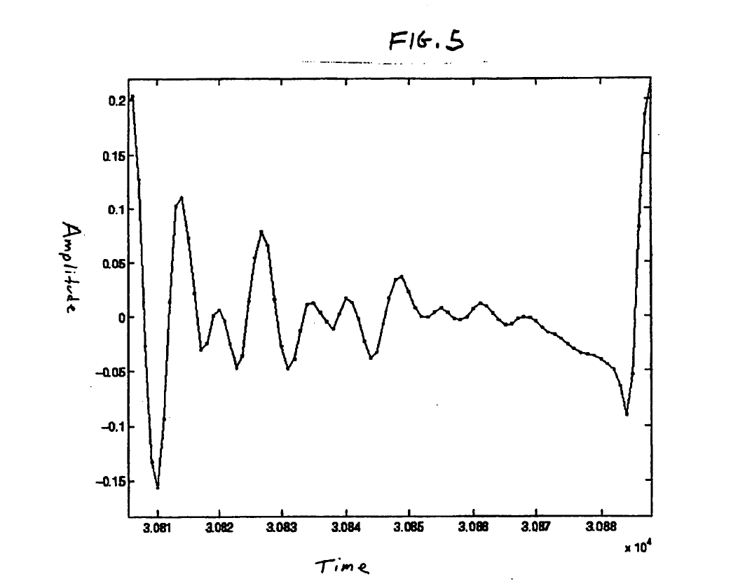

FIG. 5 shows an illustrative sampled waveform of a pitch period. The pitch period includes 82 sampling points (denoted by the dots lying on the waveform) and thus when the pitch period is vectorized, the pitch period can be represented as a single point in an 82-dimensional space.

Pitch tracking process 62 designates (86) the second primary peak as the first primary peak of the subsequent pitch period and reiterates (78)-(86).

Thus, pitch-tracking process 62 identifies the beginning point and ending point of each pitch period. Pitch tracking process 62 also accounts for the variation of time between pitch periods. This temporal variance occurs over relatively long periods of time and thus there are no radical changes in pitch period length from one pitch period to the next. This allows pitch-tracking process 62 to operate recursively, using the length of the prior period as an input to determine the duration of the next.

Pitch tracking process 62 can be stated as the following recursive function:

$$f ( {p}_{prev ,} {p}_{new} ) = \{ \begin{matrix}f ( {p}_{new} , {p}_{next} ) : \vert s - d ( {p}_{new} , {p}_{0} ) \vert \leq \vert s - d ( {p}_{prev} , {p}_{0} ) \vert \\ d ( {p}_{prev} , {p}_{0} ) : \vert s - d ( {p}_{new} , {p}_{0} ) \vert > \vert s - d ( {p}_{prev} , {p}_{0} ) \vert\end{matrix}$$

The function f(p,p′) operates on pairs of consecutive peaks p and p′ in a waveform, recurring to its previous value (the duration of the previous pitch period) until it finds the peak whose location in the waveform corresponds best to that of the first peak in the waveform. This peak becomes the first peak in the next pitch period. In the notation used here, the symbol p subscripted, respectively, by “prev,” “new,” “next” and “0,” denote the previous, the current peak being examined, the next peak being examined, and the first peak in the pitch period respectively, s denotes the time duration of the prior pitch period, and d(p,p′) denotes the duration between the peaks p and p′.

A representative example of program code (i.e., machine-executable instructions) to implement process 62 is the following code using MATHLAB:

function [a, t] = pitch(infile, peakarray)
% PITCH2 separate pitch-periods.
% PITCH2(infile, peakarray) infile is an array of a .wav
% file generally read using the wavread( ) function.
% peakarray is an array of the vectorized pitch periods of
% infile.
wave = wavread(infile);
siz = size(wave);
n = 0;
t = [0 0];
a = [];
w = 1;
count = size(peakarray);

| | |
|---|---|
| length = 120; | % set vector |
| offset = 20; | % length |
| while wave(peakarray(w)) > wave(peakarray(w+1)) | % find primary |
| w = w+1; | % peak |
| end | |
| left = peakarray(w+1); | % take real |
| y = rceps(wave); | % cepstrum of |
| x = 50; | % waveform |
| while y(x) ˜= max(y(50:125)) | |
| x = x+1; | |
| end | |

| prior = x; | | % find pitch period length |
|---|---|---|
| period = zeros(1,length); | | % estimate |
| for x = (w+1):count(1,2)−1 | | % pitch tracking |
| | right = peakarray(x+1); | % method |
| | trail = peakarray(x); | |

if (abs(prior−(right−left))>abs(prior−(trail−left)))
n = n + 1;
d = left−offset;
if (d+length) < siz(1)

t(n,:) = [offset, (offset+(trail−left))];
for y = 1:length
if (y+d−1) > 0
period(y) = wave(y+d−1);

end

end

| | |
|---|---|
| a(n,:) = period; | % generate vector |
| prior = trail−left; | % of pitch period |
| left = trail; | |
| end | |

Of course, other code (or even hardware) may be used to implement pitch-tracking process 62.

B. Principal Component Analysis

Principal component analysis is a method of calculating an orthogonal basis for a given set of data points that defines a space in which any variations in the data are completely uncorrelated. The symbol, “ [symbol] ⁿ” is defined by a set of n coordinate axes, each describing a dimension or a potential for variation in the data. Thus, n coordinates are required to describe the position of any point. Each coordinate is a scaling coefficient along the corresponding axis, indicating the amount of variation along that axis that the point possesses. An advantage of PCA is that a trend appearing to span multiple dimensions in [symbol] ⁿ can be decomposed into its “principal components,” i.e., the set of eigen-axes that most naturally describe the underlying data. By implementing PCA, it is possible to effectively reduce the number of dimensions. Thus, the total amount of information required to describe a data set is reduced by using a single axis to express several correlated variations.

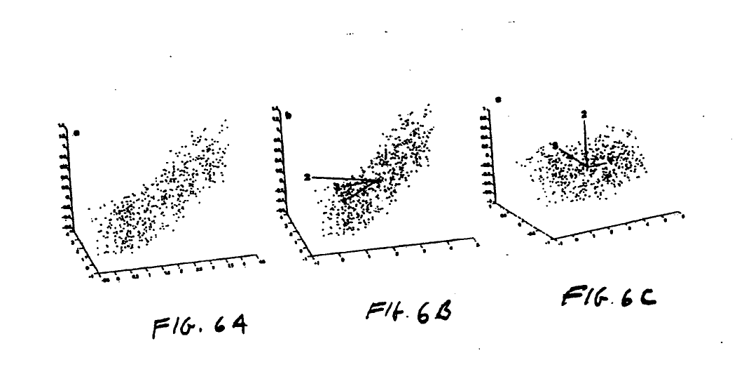

For example, FIG. 6A shows a graph of data points in 3-dimensions. The data in FIG. 6B are grouped together forming trends. FIG. 6B shows the principal components of the data in FIG. 6A. FIG. 6C shows the data redrawn in the space determined by the orthogonal principal components. There is no visible trend in the data in FIG. 6C as opposed to FIGS. 6A and 6B. In this example, the dimensionality of the data was not reduced because of the low-dimensionality of the original data. For data in higher dimensions, removing the trends in the data reduces the data's dimensionality by a factor of between 20 and 30 in routine speech applications. Thus, the purpose of using PCA in this method of speech synthesis is to describe the trends in the pitch-periods and to reduce the amount of data required to describe speech waveforms.

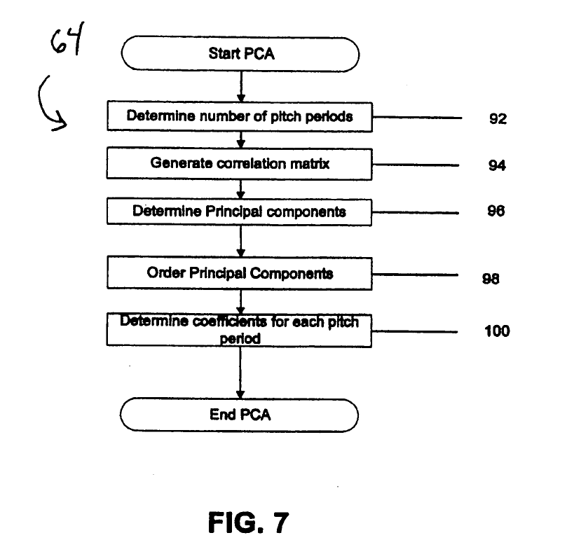

Referring to FIG. 7, principal components process 64 determines (92) the number of pitch periods generated from pitch tracking process 62. Principal components process 64 generates (94) a correlation matrix.

The actual computation of the principal components of a waveform is a well-defined mathematical operation, and can be understood as follows. Given two vectors x and y, xy^{T} is the square matrix obtained by multiplying x by the transpose of y. Each entry [xy^{T}]_{i,j} is the product of the coordinates xᵢ and yⱼ. Similarly, if X and Y are matrices whose rows are the vectors xᵢ and yⱼ, respectively, the square matrix XY^{T} is a sum of matrices of the form [xy^{T}]_{i,j}:

$${XY}^{T} = {\sum }_{i , j} {x}_{i} {y}_{j}^{T} .$$

XY^{T} can therefore be interpreted as an array of correlation values between the entries in the sets of vectors arranged in X and Y. So when X=Y, XX^{T} is an “autocorrelation matrix,” in which each entry [XX^{T}]_{i,j} gives the average correlation (a measure of similarity) between the vectors xᵢ and xⱼ. The eigenvectors of this matrix therefore define a set of axes in [symbol] ⁿ corresponding to the correlations between the vectors in X. The eigen-basis is the most natural basis in which to represent the data, because its orthogonality implies that coordinates along different axes are uncorrelated, and therefore represent variation of different characteristics in the underlying data.

Principal components process 64 determines (96) the principal components from the eigenvalue associated with each eigenvector. Each eigenvalue measures the relative importance of the different characteristics in the underlying data. Process 64 sorts (98) the eigenvectors in order of decreasing eigenvalue, in order to select the several most important eigen-axes or “principal components” of the data.

Principal components process 64 determines (100) the coefficients for each pitch period. The coordinates of each pitch period in the new space are defined by the principal components. These coordinates correspond to a projection of each pitch period onto the principal components. Intuitively, any pitch period can be described by scaling each principal component axis by the corresponding coefficient for the given pitch period, followed by performing a summation of these scaled vectors. Mathematically, the projections of each vectorized pitch period onto the principal components are obtained by vector inner products:

$${x}^{′} = {\sum }_{i = 1}^{n} ( {e}_{i} \cdot x ) {e}_{i} .$$

In this notation, the vectors x and x′ denote a vectorized pitch period in its initial and PCA representations, respectively. The vectors eᵢ are the ith principal components, and the inner product eᵢ·x is the scaling factor associated with the ith principal component.

Therefore, if any pitch period can be described simply by the scaling and summing the principal components of the given set of pitch periods, then the principal components and the coordinates of each period in the new space are all that is needed to reconstruct any pitch period.

In the present case, the principal components are the eigenvectors of the matrix SS^{T}, where the ith row of the matrix S is the vectorized ith pitch period in a waveform. Usually the first 5 percent of the principal components can be used to reconstruct the data and provide greater than 97 percent accuracy. This is a general property of quasi-periodic data. Thus, the present method can be used to find patterns that underlie quasi-periodic data, while providing a concise technique to represent such data. By using a single principal component to express correlated variations in the data, the dimensionality of the pitch periods is greatly reduced. Because of the patterns that underlie the quasi-periodicity, the number of orthogonal vectors required to closely approximate any waveform is much smaller than is apparently necessary to record the waveform verbatim.

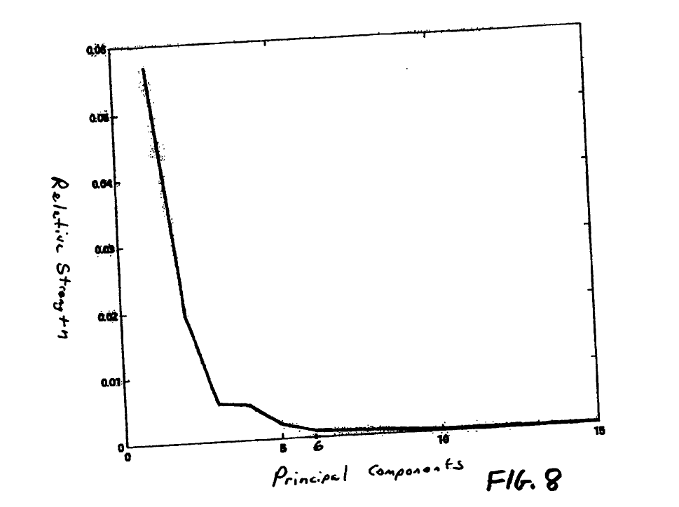

FIG. 8 shows an eigenspectrum for the principal components of the ‘aw’ phoneme. The eigenspectrum displays the relative importance of each principal component in the ‘aw’ phoneme. Here only the first 15 principal components are displayed. The steep falloff occurs far to the left on the horizontal axis. This indicates the importance of later principal components is minimal. Thus, using between 5 and 10 principal components would allow reconstruction of more than 95% of the original input signal. The optimum tradeoff between accuracy and number of bits transmitted typically requires six principal components. Thus, the eigenspectrum is a useful tool in determining how many principal components are required for the speech synthesis of a given phoneme (speech sound).

A representative example of program code (i.e., machine-executable instructions) to implement principal components process 64 is the following code using MATHLAB:

| function [v,c] = pca(periodarray, Nvect) | |
|---|---|
| % PCA principal component analysis | |
| % pca(periodarray) performs principal component analysis on an | |
| % array where each row is an observation (pitch-period) and | |
| % each column a variable. | |
| n = size(periodarray); | % find # of pitch periods |
| n = n(1); | |
| l = size(periodarray(1,:)); | |
| v = zeros(Nvect, l(2)); | |
| c = zeros(Nvect, n); | |
| e = cov(periodarray); | % generate correlation matrix |
| [vects, d] = eig(e); | % compute principal components |
| vals = diag(d); | |
| for x = 1:Nvect | % order principal components |

| y = 1; | |
|---|---|
| while vals(y) ˜= max(vals); | |
| y = y + 1; | |
| end | |
| vals(y) = −1; | |
| v(x,:) = vects(:,y)′; | % compute coefficients for |
| for z = 1:n | % each period |

c(x,z) = dot(v(x,:), periodarray(z,:));

end

end

Of course, other code (or even hardware) may be used to implement principal components process 64.

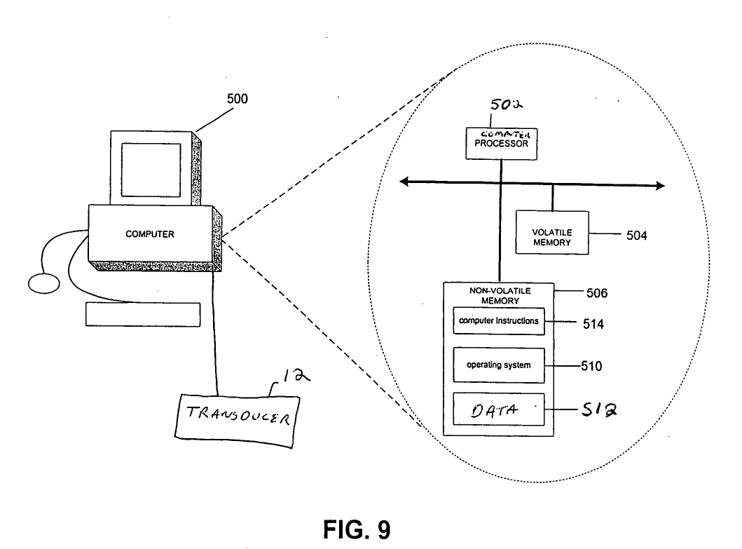

FIG. 9 shows a computer 500 for speech synthesis using process 30. Computer 500 includes a computer processor 502, a memory 504, and a storage medium 506 (e.g., read only memory, flash memory, disk etc.). The computer can be a general purpose or special purpose computer, e.g., controller, digital signal processor, etc. Storage medium 506 stores operating system 510, data 512 for speech synthesis (e.g., principal components), and computer instructions 514 which are executed by computer processor 502 out of memory 504 to perform process 30.

Process 30 is not limited to use with the hardware and software of FIG. 9; it may find applicability in any computing or processing environment and with any type of machine that is capable of running a computer program. Process 30 may be implemented in hardware, software, or a combination of the two. For example, process 30 may be implemented in a circuit that includes one or a combination of a processor, a memory, programmable logic and logic gates. Process 30 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 30 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform process 30. Process 30 may also be implemented as a machine-readable storage medium, configured with a computer program, where upon execution, instructions in the computer program cause the computer to operate in accordance with process 30.

The processes are not limited to the specific embodiments described herein. For example, the processes are not limited to the specific processing order of FIGS. 2, 3, and 7. Rather, the blocks of FIGS. 2, 3, and 7 may be re-ordered, as necessary, to achieve the results set forth above.

In other embodiments, principal components processor 28 and speech synthesis processor 18 may be combined. In other embodiments, principal components processor 28 is detached from speech synthesizer 10, once a desired amount of principal components are stored.

Other embodiments not described herein are also within the scope of the following claims.

1. A method for speech synthesis, comprising:
combining principal components corresponding to a phoneme with a set of coefficients to produce a signal representing a synthesized expression of the phoneme.

2. The method of claim 1, further comprising:
applying the synthesized expression to a transducer to generate synthesized speech.

3. The method of claim 1, further comprising:
generating the phoneme from text.

4. The method of claim 1, further comprising:
receiving speech spoken from a user; and
extracting the set of coefficients.

5. The method of claim 4 wherein extracting the set of coefficients comprises:
changing the set of coefficients to include changes in intonation.

6. The method of claim 1, further comprising:
extracting the principal components from a database.

7. An article comprising a machine-readable medium that stores executable instructions for speech synthesis, the instructions causing a machine to:
combine principal components corresponding to a phoneme with a set of coefficients to produce a signal representing a synthesized expression of the phoneme.

8. The article of claim 7, further comprising instructions causing a machine to:
apply the synthesized expression to a transducer to generate synthesized speech.

9. The article of claim 7, further comprising instructions causing a machine to:
generate the phoneme from text.

10. The method of claim 7, further comprising instructions causing a machine to:
receive speech spoken from a user; and
extract the set of coefficients.

11. The article of claim 10 wherein instructions causing a machine to extract the set of coefficients comprises instructions causing a machine to:
change the set of coefficients to include changes in intonation.

12. The article of claim 7, further comprising instructions causing a machine to:
extract the principal components from a database.

13. An apparatus comprising:
a memory that stores executable instructions for speech synthesis; and
a processor that executes the instructions to:
combine principal components corresponding to a phoneme with a set of coefficients to produce a signal representing a synthesized expression of the phoneme.

14. The apparatus of claim 13, further comprising instructions to:
apply the synthesized expression to a transducer to generate synthesized speech.

15. The apparatus of claim 13, further comprising instructions to:
generate the phoneme from text.

16. The apparatus of claim 13, further comprising instructions to:
receive speech spoken from a user; and
extract the set of coefficients.

17. The apparatus of claim 16 wherein instructions to extract the set of coefficients comprises instructions to:
change the set of coefficients to include changes in intonation.

18. The apparatus of claim 13, further comprising instructions to:
extract the principal components from a database.
